(19) United States
(12) Patent Application Publication
(10) Pub. No.: US 2016/0034122 A1
(43) Pub. Date: Feb. 4, 2016

(54) Method and Apparatus for Recording User Actions During a Course of Rendering a Series of Visualizations

(71) Applicant: Wal-Mart Stores, Inc., Bentonville, AR (US)

(72) Inventors: Donald R. High, Noel, MO (US); Mike Atchley, Springdale, AR (US); John P. Thompson, Bentonville, AR (US); Luke Lowery, Bella Vista, AR (US)

(21) Appl. No.: 14/812,482

(22) Filed: Jul. 29, 2015

Related U.S. Application Data
(60) Provisional application No. 62/030,962, filed on Jul. 30, 2014.

(51) Int. Cl. G06F 3/0484; G06F 17/24; G06F 9/30; G06F 3/0488

(52) U.S. Cl. CPC G06F 3/0484; G06F 3/0488; G06F 17/24; G06F 9/3017

(57) ABSTRACT

A control circuit, during a course of rendering a series of visualizations over time via a plurality of displays, records user actions as entered via one or more user-input interfaces. The control circuit stores a sequence of these recorded user actions as correspond to the series of visualizations.

### RELATED APPLICATION(S)

This application claims the benefit of U.S. Provisional application No. 62/030,962, filed Jul. 30, 2014, which is incorporated by reference in its entirety herein.

### TECHNICAL FIELD

These teachings relate generally to the presentation of computer-based visualizations.

### BACKGROUND

Data mining is known in the art and, generally speaking, pertains to discovering patterns in large data sets. Such processing often includes extracting information from a data set and transforming that information into an understandable structure for further use. Such practices often involve database and data management aspects, data preparation, aggregation of values, the execution of statistical models and/or inference considerations, interestingness metrics, complexity considerations, post-processing of discovered structures, and the development of corresponding visualizations.

Notwithstanding the potent capabilities of computers to facilitate such activities, in many cases such automated “number crunching” serves only as a counterpart to human analysis and insight. Human-based analysis, in turn, often benefits from a series of interactions with a given presentation of information (such as one or more visualizations as corresponds to execution of a statistical analysis of interest). For example, a user may vary one or more variables to assess a corresponding impact upon the statistical analysis.

Even when a seemingly-useful result is attained through such back-and-forth interaction with an executable statistical model, it can be useful to understand the various considerations that were taken into account on the way to reaching that result. Many prior art approaches in these regards offer no useful history in these regards to support such an interest. Furthermore, prior art practices in general tend to be too limited in scope and capacity to support more than only a modest level of activity and follow-on interaction.

### BRIEF DESCRIPTION OF THE DRAWINGS

The above needs are at least partially met through provision of the method and apparatus for recording user actions during a course of rendering a series of visualizations described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings;

FIG. 3 comprises a block diagram as configured in accordance with various embodiments of these teachings;

FIG. 4 comprises a series of screenshots as configured in accordance with various embodiments of these teachings;

FIG. 5 comprises a series of screenshots as configured in accordance with various embodiments of these teachings;

FIG. 6 comprises a series of screenshots as configured in accordance with various embodiments of these teachings;

FIG. 7 comprises a flow diagram as configured in accordance with various embodiments of the invention;

FIG. 8 comprises a series of screenshots as configured in accordance with various embodiments of these teachings;

FIG. 9 comprises a series of screenshots as configured in accordance with various embodiments of the invention;

FIG. 10 comprises a series of screenshots as configured in accordance with various embodiments of these teachings; and

FIG. 11 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a control circuit, during a course of rendering a series of visualizations over time via a plurality of displays, records user actions as entered via one or more user-input interfaces. The control circuit stores a sequence of these recorded user actions as correspond to the series of visualizations.

These teachings will accommodate a variety of user-input interfaces including, but not limited to, cursor-control devices, touch-screen interfaces, gesture-recognition interfaces, voice-recognition interfaces, and so forth. These teachings will also accommodate having the primary control circuit interface with the aforementioned displays via intervening physically discrete processors. In such a case, and where the displays comprise touch-screen interfaces, the aforementioned user actions can be entered via such touch-screen interfaces and communicated to the primary control circuit via those intervening physically discrete processors.

So configured, these teachings will facilitate leveraging the stored sequence of recorded user actions in various ways. As one example in these regards, the primary control circuit can later recall from memory the stored sequence of recorded user actions and execute that sequence to yield corresponding visualizations. In some cases, those reproduced visualizations can be identical to the visualizations that correspond to the original user actions. In other cases, for example when at least some of the relevant variables have changed over time, the new visualizations can be different from the original visualizations notwithstanding the playback of a same sequence of user actions.

As another example in these regards, the primary control circuit can later recall from memory the stored sequence of recorded user actions to thereby facilitate user editing of that sequence to thereby produce an edited sequence of the recorded user actions. In such a case the primary control circuit can then, if desired, execute that edited sequence of recorded user actions to provide a corresponding series of visualizations via the aforementioned plurality of displays.

So configured these teachings make it possible for users to later revisit their own thinking process and record of interaction with a given statistical analysis. Such a record can be useful, by one approach, to test the completeness and/or thoroughness of their earlier analysis. By another approach, such a record can serve as a kind of macro instruction to facilitate easy execution of a series of analytical steps that are useful to the user notwithstanding (or even because of) a changed data set.

These teachings are readily leveraged in conjunction with a plurality of displays that share a common physical presentation zone. These teachings will also accommodate, however, remotely distributed displays if so desired.

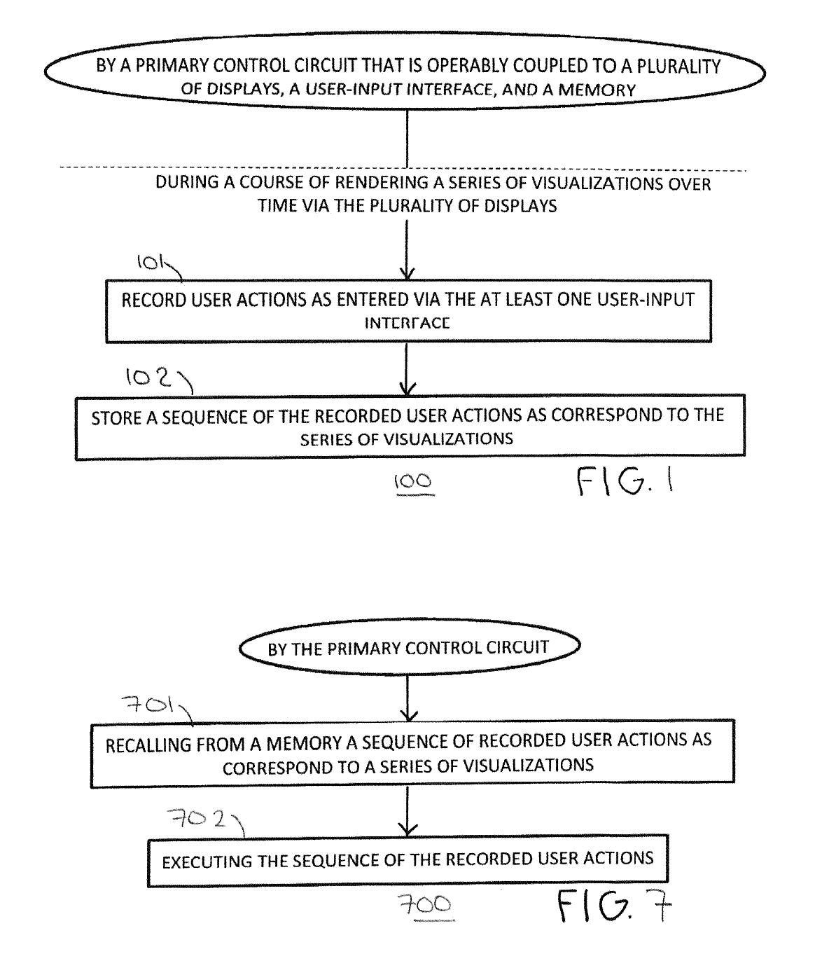

These and other benefits may become clearer upon making a thorough review and study of the following detailed description. Referring now to the drawings, and in particular to FIG. 1, an illustrative process 100 that is compatible with many of these teachings will now be presented.

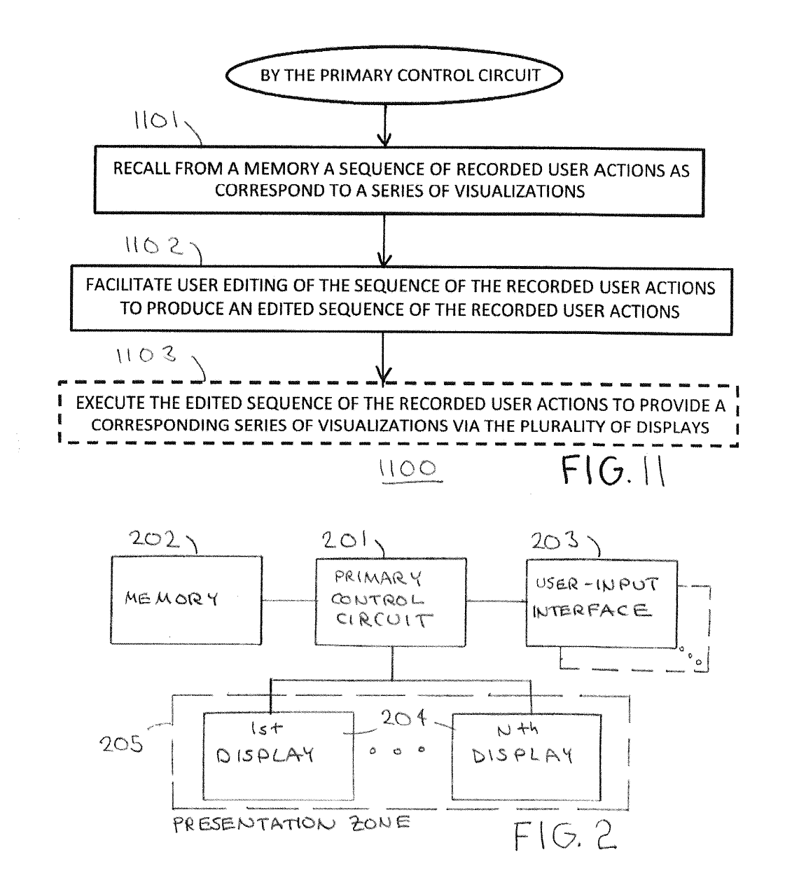

With momentary reference to FIG. 2, for the sake of an illustrative example it will be presumed here that a primary control circuit 201 carries out this process 100. Such a primary control circuit 201 can comprise a fixed-purpose hard-wired platform or can comprise a partially or wholly programmable platform. These architectural options are well known and understood in the art and require no further description here. This primary control circuit 201 is configured (for example, by using corresponding programming as will be well understood by those skilled in the art) to carry out one or more of the steps, actions, and/or functions described herein.

In this illustrative example the enabling system also includes a memory 202, one or more input interfaces 203, and a plurality of displays 204 that all operably couple to the primary control circuit 201. The memory 202 may be integral to the primary control circuit 201 or can be physically discrete (in whole or in part) from the primary control circuit 201 as desired. This memory 202 can also be local with respect to the primary control circuit 201 (where, for example, both share a common circuit board, chassis, power supply, and/or housing) or can be partially or wholly remote with respect to the primary control circuit 201 (where, for example, the memory 202 is physically located in another facility, metropolitan area, or even country as compared to the primary control circuit 201).

This memory 202 can serve, for example, to non-transitorily store the computer instructions that, when executed by the primary control circuit 201, cause the primary control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the memory 202 also serves to store at least one executable statistical analysis. By one approach the executable statistical analysis represents a retail sales enterprise (including, for example, one or more publicly-accessible retail sales stores, one or more distribution centers and warehouses, and/or one or more transportation fleets by which goods are moved from and between manufacturers, distribution centers/warehouses, and retail sales stores). In a typical application setting the executable statistical analysis, when executed, provides at least one analytical result as a function of numerous variables. Example analytical results can include, but are certainly not limited to, sales figures, costs, gross and net income, pricing, and so forth. Such executable statistical analyses are known in the art. As the present teachings are not particularly sensitive to any specific choices in these regards, further elaboration will not be provided here regarding executable statistical analyses.

The aforementioned user-input interfaces 203 can comprise any of a variety of known mechanisms and methodologies in these regards. Examples include but are not limited to touch-screen interfaces, cursor control devices, gesture-recognition interfaces, and voice-recognition interfaces, to note but a few. Generally speaking, these user-input interfaces 203 provide ways for a user to input instructions and/or data to the primary control circuit 201. As one simple but relevant example in these regards, such a user-input interface 203 can permit a user to change a variable in a corresponding statistical analysis. The primary control circuit 201 can then re-execute that statistical analysis using that modified variable to thereby generate corresponding visualizations that are presented via the plurality of displays 204.

The aforementioned displays 204 can comprise, for example, any of a variety of flat-screen displays as are known in the art as well as front and rear projection systems. By one approach these displays can comprise touch-screen displays and hence can receive user input via contact with the screen. The number and size of the displays can vary with the needs of the application setting. As one illustrative example in these regards, the primary control circuit 201 may operably couple to five large flat screen displays that are all more-or-less horizontally aligned in a shared presentation zone 205 that is enclosed, for example, within a secured room. Various display technologies are known in the art and the present teachings are not particularly sensitive to any particular selections in these regards. Accordingly, further elaboration will not be provided here for the sake of brevity.

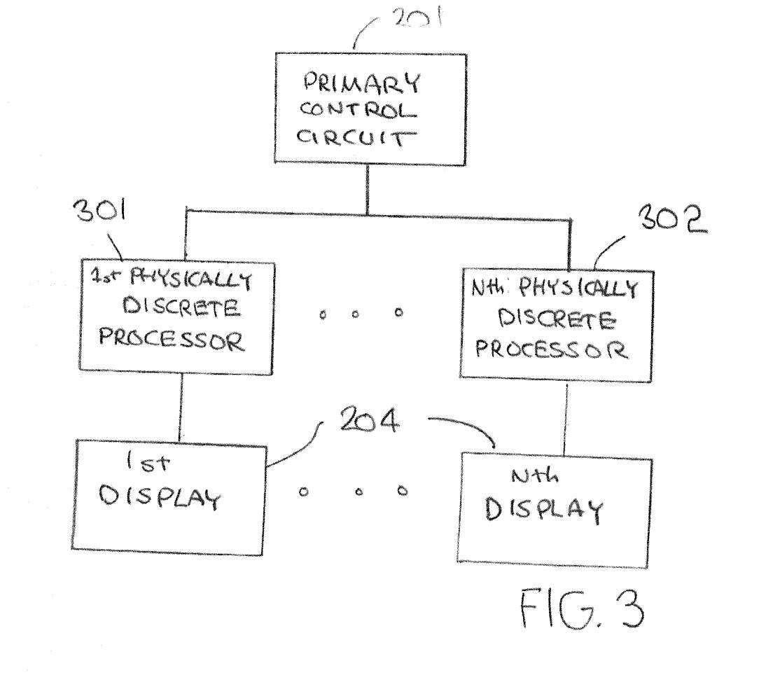

The present teachings are highly flexible with respect to the overall enabling architecture employed. By one approach, and as is suggested by the illustration shown in FIG. 2, the primary control circuit 201 may directly drive the aforementioned displays 204. These teachings will accommodate, however, having the primary control circuit 201 interact with at least some displays 204 in a less direct fashion. For example, as illustrated in FIG. 3, the primary control circuit 201 may operably couple to a plurality of physically discrete processors (represented here by a first physically discrete processor 301 through an Nth physically discrete processor 302, where the “N” comprises an integer greater than 1) wherein the latter directly control and drive the aforementioned displays 204. These physically discrete processors can comprise, for example, stand-alone computers such as a desktop computer or a rack-mount computer.

Referring again specifically to FIG. 1, the illustrated process 100 occurs during a course of rendering a series of visualizations over time via the plurality of displays 204. As noted above, these visualizations can represent inputs and/or outputs to and from an executable statistical analysis as executed by the primary control circuit 201. FIG. 4 provides a simple illustrative example in these regards where the primary control circuit 201 presents such visualizations via three displays 204.

In this simple example the display 204 on the far left presents some touch-screen-based user interfaces. In particular, this visualization includes an upwardly-directed arrow 401 and a downwardly-directed arrow 402 by which a user can increase or decrease the value of some corresponding variable. This visualization also includes a virtual rotatable knob 403 by which the user can increase or decrease some other corresponding variable. The middle and far-right displays 204, in turn, present a first output visualization 404 and a second output visualization 405, respectively, comprising charts of various kinds that represent certain calculated outputs of the corresponding executable statistical analysis.

At block 101 in this process 100, the control circuit 201 records user actions as are entered via the one or more user-input interfaces 203. At block 102 the control circuit 201 stores the resultant sequence of those recorded user actions as correspond to the series of visualizations. Importantly, these recording and storage activities do not represent storing the visualizations themselves. Instead, the control circuit 201 is recording and storing the actual user actions as were entered via one or more available user-input interfaces 203.

FIGS. 5 and 6 provide simple illustrative examples in the foregoing regards. In FIG. 5 the user 501 asserts the downwardly-directed arrow 402 to thereby reduce the particular variable that corresponds to that particular user-input interface. The control circuit 201 re-executes the executable statistical analysis to provide modified visualizations 404 and 405 as correspond to the newly-calculated results and displays those modified visualizations on the middle and far-right displays 204. In FIG. 6 the user 501 next asserts the virtual knob 403 by virtually rotating that knob counter-clockwise by some corresponding amount of rotation. This input again serves to modify a corresponding variable. Accordingly, the control circuit 201 again re-executes the executable statistical analysis and again provides modified visualizations 404 and 405 as correspond to the newly-calculated results.

The foregoing constitutes but a few examples of the kinds of user inputs, and the sequence by which these user inputs are entered, that the primary control circuit 201 records and stores as per the foregoing process 100. If desired, the primary control circuit 201 could also record and store the time that passes between each such user assertion. For many application settings, however, such temporal information is irrelevant and need not be recorded or stored.

These teachings are highly flexible and will accommodate numerous modifications and embellishments as desired. By one approach, for example, various user-input interfaces 203 can be parsed out over two or more of the displays 204 and/or can constitute stand-alone mechanisms such as a mouse or trackpads. Notwithstanding the distributed nature of the user-input interfaces 203, these teachings can nevertheless provide for recording and storing inputs as entered (in sequence) by any such interface.

Or, if desired, the primary control circuit 201 can be configured to only record and store user inputs as are entered via specific ones of a plurality of user-input interfaces 203. So configured, user inputs entered via some user-input interfaces 203 will pass transparently with respect to the recording process provided by this process 100 while other user inputs are preserved.

As yet another example in these regards, when a plurality of users are present and interacting with the system, the primary control circuit 201 may be configured to only record and store user inputs as are entered by particular participants (such as the highest ranking executive in the audience) and to not record/store user inputs from other participants.

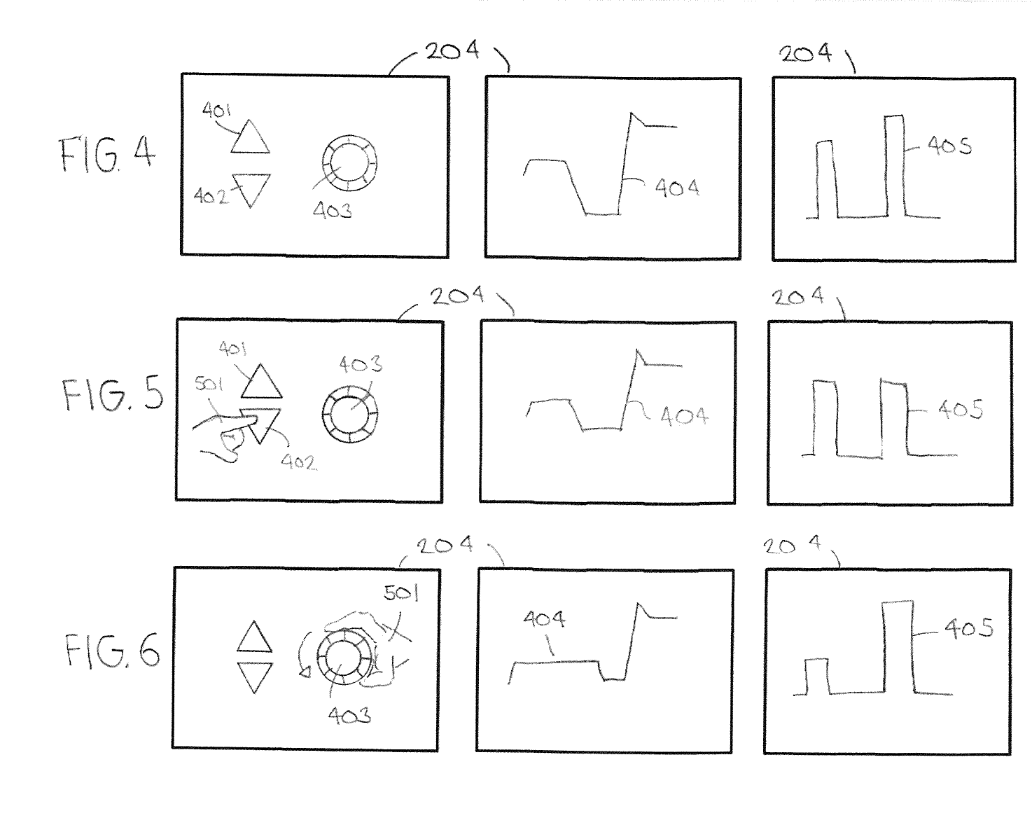

In any event, the resultant stored sequence of the recorded user actions can be leveraged in a variety of ways. FIG. 7 illustrates one process 700 in these regards. In this example the primary control circuit 201, at block 701, recalls from the memory 202 the previously stored sequence of recorded user actions as correspond to that original series of visualizations. The primary control circuit 201 can then execute, at block 702, that recalled sequence of recorded user actions. By one approach the primary control circuit 201 automatically executes those recalled user actions in accordance with their original sequence of execution. Each user action can be executed in order following some predetermined time interval such as one second, five seconds, 10 seconds, or the like.

By another approach, the primary control circuit 201 executes the recalled recorded user actions in sequence but only in incremental response to some user input. FIGS. 8 through 10 provide an illustrative example in these regards. In FIG. 8 the re-execution of the recalled recorded user actions presents an initial set of visualizations as correspond to the executable statistical analysis. In this example the output visualizations 404 and 405 are the same as the original visualizations shown in FIG. 4 because the executable statistical analysis is operating with a same set of initial input values.

These teachings will readily accommodate, however, executing the relevant executable statistical analysis using one or more different input values as may reflect new, updated information due to the passage of time. In such a case, however, the initial-state output visualizations will very likely be different from the original visualizations when the user inputs were recorded and stored. Such a result is not only possible but in fact expected and likely useful in many application settings. Again, the recording and storage process 100 described above provides for recording and storing user inputs with respect to the execution of an executable statistical analysis and not the recording and storage of the resulting visualizations themselves.

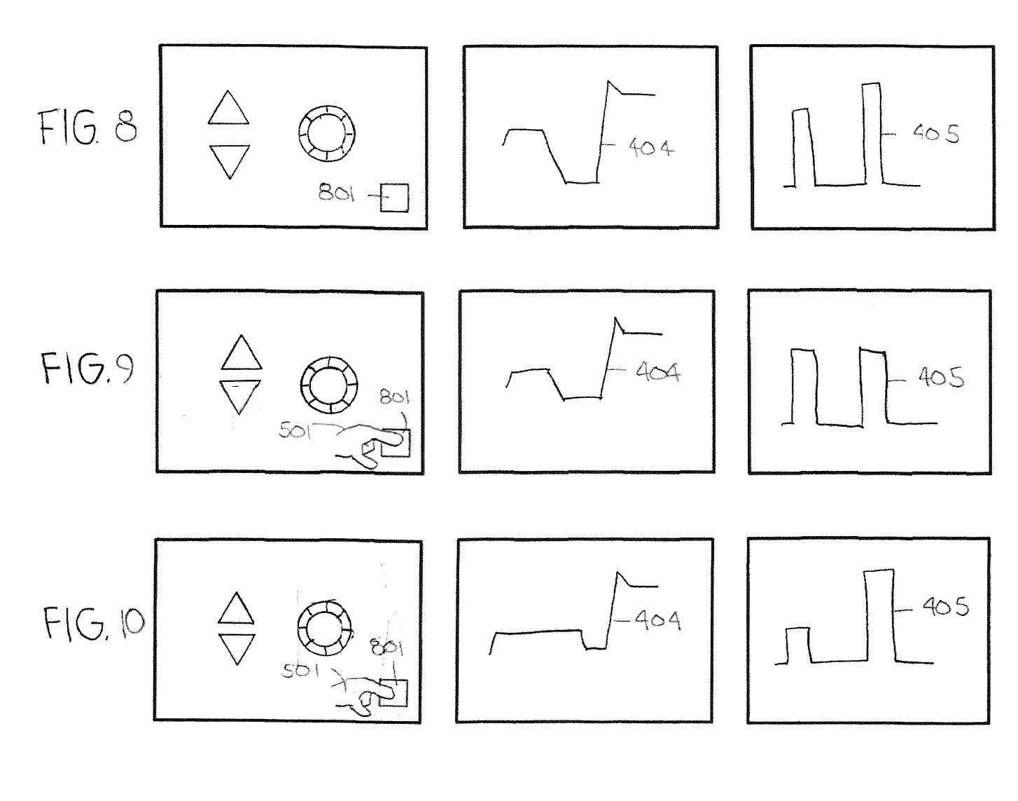

When recalling and executing the sequence of recorded user actions, the primary control circuit 201 can provide a user input opportunity 801 to instruct the primary control circuit 201 to incrementally step through the execution of the sequence of recorded user actions. To illustrate, in FIG. 9 the user 501 asserts this user input opportunity 801 and thereby causes the primary control circuit 201 to effect the user action as described in conjunction with FIG. 5 above. The re-calculated results are shown as the resultant visualizations 404 and 405 (which again happen to be the same as the original visualizations that resulted from this particular user action as described above, though such a result is not a requirement of these teachings). When the user 501 again asserts this user input opportunity 801 as shown in FIG. 10, the primary control circuit 201 again steps through the recorded sequence of recorded user actions to effect the next recorded user action as was described above with respect to FIG. 6. The resultant visualizations are then again presented.

So configured, the user can step through the previous series of interactions and pause for as long as they wish at any particular point to consider the results. Such an approach can be particularly useful when the sequence of interactions provide a series of useful insights and views for a particular categorical analysis on some repeated basis (such as a daily basis, a weekly basis, a monthly basis, or the like) as the underlying data and input values themselves change in accordance with their ordinary dynamic nature over time.

FIG. 11 presents another process 1100 that illustrates yet another way by which such recorded and stored information can be leveraged. Pursuant to this process 1100 the primary control circuit 201, at block 1101, recalls from the memory 202 the sequence of recorded user actions as correspond to an original series of visualizations. At block 1102 the primary control circuit 201 facilitates user editing of that recorded and stored sequence of user actions to thereby produce an edited sequence of the recorded user actions. This editing might comprise, for example, deleting a particular user action from the sequence, re-ordering the sequence by which the user actions take place, or modifying the nature or extent of the user action itself. For example, when the user action constitutes turning a virtual knob, this editing may constitute shortening or lengthening the rotation distance and/or reversing the direction of rotation. By another approach the editing may serve to introduce a new user action that is located between two previously-recorded user actions.

Such an editing capability will permit a user to, for example, fine tune or correct a particular sequence of user actions that are generally useful but which are improved by this editing. In particular, the user can achieve the benefits of such editing without being required to record an entire new sequence of user actions in order to achieve the desired result.

In any event, at optional block 1103 the primary control circuit 201 can then selectively execute that edited sequence of recorded user actions to thereby provide a corresponding series of visualizations via the plurality of displays 204. By storing that edited sequence, the user can later recall that edited sequence at any time of need or convenience. These teachings will support any of a variety of naming conventions by which the user can identify original recorded sequences and/or edited sequences to further aid in their identification, selection, editing, and usage.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a plurality of displays;
at least one user-input interface;
a memory; and
a primary control circuit operably coupled to the plurality of displays, the user-input interface, and the memory, the primary control circuit configured to:
during a course of rendering a series of visualizations over time via the plurality of displays, record user actions as entered via the at least one user-input interface and store a sequence of the recorded user actions as correspond to the series of visualizations.

2. The apparatus of claim 1 wherein the plurality of displays share a common presentation zone.

3. The apparatus of claim 1 wherein the at least one user-input interface comprises a plurality of touch screens as comprise corresponding parts of the plurality of displays.

4. The apparatus of claim 3 further comprising:
a physically discrete processor for each of the displays, wherein the primary control circuit operably couples to the plurality of displays via each such physically discrete processor.

5. The apparatus of claim 4 wherein at least some of the user actions that are recorded by the primary control circuit constitute user actions that are entered via at least one of the touch screens and wherein information regarding the user actions is provided to the primary control circuit by a corresponding one of the physically discrete processors.

6. The apparatus of claim 1 wherein the at least one user-input interface comprises a plurality of user-input interfaces selected from a group comprising:
a cursor control device;
a touch-screen interface;
a gesture-recognition interface;
a voice-recognition interface.

7. The apparatus of claim 1 wherein the primary control circuit is further configured to:
recall from the memory the sequence of the recorded user actions as correspond to the series of visualizations and execute the sequence of the recorded user actions.

8. The apparatus of claim 7 wherein the primary control circuit executes the sequence of the recorded user actions in a step-by-step manner in response to corresponding sequential user inputs.

9. The apparatus of claim 1 wherein the primary control circuit is further configured to:
recall from the memory the sequence of the recorded user actions as correspond to the series of visualizations and facilitate user editing of the sequence of the recorded user actions to produce an edited sequence of the recorded user actions.

10. The apparatus of claim 9 wherein the primary control circuit is further configured to:
execute the edited sequence of the recorded user actions to provide a corresponding series of visualizations via the plurality of displays.

11. A method comprising:
by a primary control circuit that is operably coupled to a plurality of displays, a user-input interface, and a memory:
during a course of rendering a series of visualizations over time via the plurality of displays, recording user actions as entered via the at least one user-input interface and storing a sequence of the recorded user actions as correspond to the series of visualizations.

12. The method of claim 11 wherein the plurality of displays share a common presentation zone.

13. The method of claim 11 wherein the at least one user-input interface comprises a plurality of touch screens as comprise corresponding parts of the plurality of displays.

14. The method of claim 13 wherein there is a physically discrete processor for each of the displays, wherein the primary control circuit operably couples to the plurality of displays via each such physically discrete processor, and wherein at least some of the user actions that are recorded by the primary control circuit constitute user actions that are entered via at least one of the touch screens and information regarding the user actions is provided to the primary control circuit by a corresponding one of the physically discrete processors.

15. The method of claim 11 wherein the at least one user-input interface comprises a plurality of user-input interfaces selected from a group comprising:
a cursor control device;
a touch-screen interface;
a gesture-recognition interface;
a voice-recognition interface.

16. The method of claim 11 further comprising:
recalling from the memory the sequence of the recorded user actions as correspond to the series of visualizations and executing the sequence of the recorded user actions.

17. The method of claim 16 wherein executing the sequence of the recorded user actions comprises executing the sequence of the recorded user actions in a step-by-step manner in response to corresponding sequential user inputs.

18. The method of claim 11 further comprising:
recalling from the memory the sequence of the recorded user actions as correspond to the series of visualizations and facilitating user editing of the sequence of the recorded user actions to produce an edited sequence of the recorded user actions.

19. The method of claim 18 further comprising:
executing the edited sequence of the recorded user actions to provide a corresponding series of visualizations via the plurality of displays.
